(19) United States
(12) Patent Application Publication
(10) Pub. No.: US 2019/0251193 A1
(43) Pub. Date: Aug. 15, 2019

(54) METHOD AND SYSTEM FOR MANAGING REDUNDANT, OBSOLETE, AND TRIVIAL (ROT) DATA

(71) Applicant: Wipro Limited, Bangalore (IN)

(72) Inventor: Radha Krishna Singuru, Telangana (IN)

(21) Appl. No.: 15/937,409

(22) Filed: Mar. 27, 2018

(30) Foreign Application Priority Data
Feb. 12, 2018 (IN) 201841005283

(51) Int. Cl. G06F 17/30; G06N 99/00; G06N 7/00

(52) U.S. Cl. CPC G06F 17/30303; G06F 17/30011; G06N 7/00; G06N 99/005

(57) ABSTRACT

This disclosure relates generally to data management, and more particularly to method and system for managing redundant, obsolete, and trivial (ROT) data. In one embodiment, a method for managing ROT documents is disclosed. The method includes receiving a document, and classifying the document into a normal document or a ROT document along with a confidence score using a document classification model. The document classification model may be a domain contextualized machine learning model. The method further includes managing the document according to a document management policy based on the classification and the confidence score.

This application claims the benefit of Indian Patent Application Serial No. 201841005283 filed Feb. 12, 2018, which is hereby incorporated by reference in its entirety.

### FIELD

This disclosure relates generally to data management, and more particularly to method and system for managing redundant, obsolete, and trivial (ROT) data.

### BACKGROUND

Typically, a business organization tends to collect and store a large number of documents that contain a huge amount of data. As will be appreciated, the data may continue to be stored even when no business value may be derived from such data. In some cases, such data may include redundant, obsolete, and trivial (ROT) data that needs to be discarded or handled in an efficient and effective manner. The ROT data may include data that do not have a proper format such as unstructured data like emails, chat scripts, whitepapers, images, video files and so forth.

Continued storage of the ROT data without proper data management policy may cause various issues such as unnecessary storage or maintenance costs, compliance costs, security vulnerability issues, and so forth. For example, redundant and trivial data may consume more storage, while obsolete data may provide poor data that may impact certain decision-making processes based on data analytics. Additionally, in certain scenarios, the ROT data may include information that may be used in gaining insights on the business or the business organization. However, lack of the understanding into the ROT data may lead to financial or legal liability. For example, the ROT data may hold sensitive information that may require different levels of access or permission for different individuals. Access of such ROT data by unauthorized individuals may expose the sensitive information and put the business organization at risk. Further, in certain scenarios, the ROT data may be covered by a regulatory policy (for example, retaining medical records upto a certain pre-defined period). In such cases, improper storage or handling of the ROT data may lead to costly sanctions. For example, the business organization may be penalized when a specific data is requested as a part of its legal requirement and it is unable to locate the specific data.

### SUMMARY

In one embodiment, a method for managing redundant, obsolete, and trivial (ROT) documents is disclosed. In one example, the method may include receiving a document. The method may further include classifying the document into a normal document or a ROT document along with a confidence score using a document classification model. The document classification model may be a domain contextualized machine learning model. The method may further include managing the document according to a document management policy based on the classification and the confidence score.

In one embodiment, a system for managing ROT documents is disclosed. In one example, the system may include at least one processor and a memory communicatively coupled to the at least one processor. The memory may store processor-executable instructions, which, on execution, may cause the processor to receive a document. The processor-executable instructions, on execution, may further cause the processor to classify the document into a normal document or a ROT document along with a confidence score using a document classification model. The document classification model may be a domain contextualized machine learning model. The processor-executable instructions, on execution, may further cause the processor to manage the document according to a document management policy based on the classification and the confidence score.

In one embodiment, a non-transitory computer-readable medium storing computer-executable instructions for managing ROT documents is disclosed. In one example, the stored instructions, when executed by a processor, may cause the processor to perform operations including receiving a document. The operations may further include classifying the document into a normal document or a ROT document along with a confidence score using a document classification model. The document classification model may be a domain contextualized machine learning model. The operations may further include managing the document according to a document management policy based on the classification and the confidence score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for managing redundant, obsolete, and trivial (ROT) data in accordance with some embodiments of the present disclosure.

FIG. 2 is a functional block diagram of a ROT data management engine in accordance with some embodiments of the present disclosure.

FIG. 3 is a flow diagram of an exemplary process for managing ROT documents in accordance with some embodiments of the present disclosure.

FIG. 4 is a flow diagram of a detailed exemplary process for managing ROT documents in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

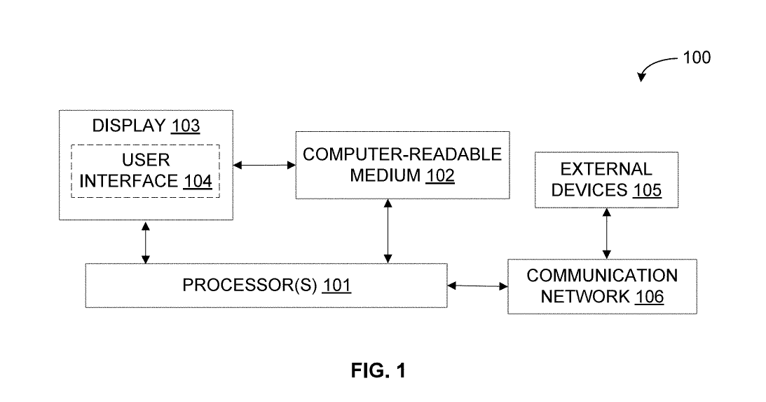

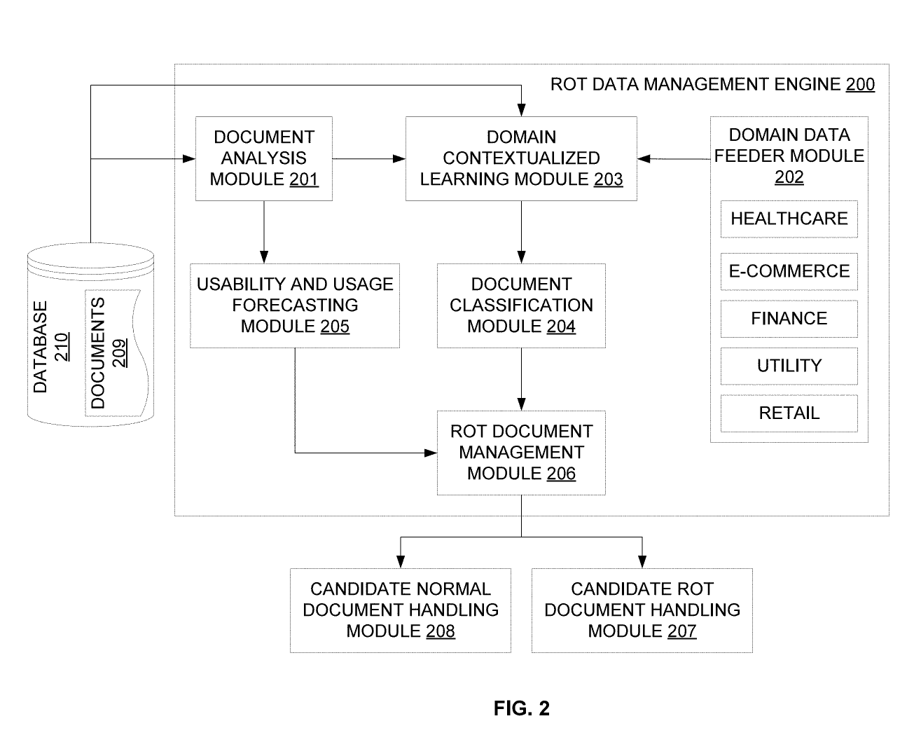

Referring now to FIG. 1, an exemplary system 100 for managing redundant, obsolete, and trivial (ROT) data is illustrated in accordance with some embodiments of the present disclosure. In particular, the system 100 may include a ROT data management device (for example, server, desktop, laptop, notebook, netbook, tablet, smartphone, mobile phone, or any other computing device) that implements a ROT data management engine so as to manage ROT data. It should be noted that, in some embodiments, the ROT data management engine may identify and manage ROT documents from among a number of documents. As will be described in greater detail in conjunction with FIGS. 2-4, the ROT data management engine may receive a document, classify the document into a normal document or a ROT document along with a confidence score using a document classification model, and manage the document according to a document management policy based on the classification and the confidence score. The document classification model may be a domain contextualized machine learning model.

The system 100 may include one or more processors 101, a computer-readable medium (for example, a memory) 102, and a display 103. The computer-readable storage medium 102 may store instructions that, when executed by the one or more processors 101, cause the one or more processors 101 to manage ROT documents in accordance with aspects of the present disclosure. The computer-readable storage medium 102 may also store various data (for example, documents, domain contextualized machine learning model, normal documents, ROT documents, confidence scores of classification, document management policy, domain knowledge, document attributes, training data, usage pattern, usability pattern, document access and modification history, and the like.) that may be captured, processed, and/or required by the system 100. The system 100 may interact with a user via a user interface 104 accessible via the display 103. The system 100 may also interact with one or more external devices 105 over a communication network 106 for sending or receiving various data. The external devices 105 may include, but are not limited to, a remote server, a digital device, or another computing system.

Referring now to FIG. 2, a functional block diagram of the ROT data management engine 200, implemented by the system 100 of FIG. 1, is illustrated in accordance with some embodiments of the present disclosure. The ROT data management engine 200 may include various modules that perform various functions so as to identify and manage ROT data. In some embodiments, the ROT data management engine 200 may include a document analysis module 201, a domain data feeder module 202, a domain contextualized learning module 203, a document classification module 204, a usability and usage forecasting module 205, and a ROT document management module 206. Additionally, in some embodiments, the ROT data management engine 200 may include a candidate ROT document handling module 207, and a candidate normal document handling module 208. As will be appreciated by those skilled in the art, all such aforementioned modules 201-208 may be represented as a single module or a combination of different modules. Moreover, as will be appreciated by those skilled in the art, each of the modules 201-208 may reside, in whole or in parts, on one device or multiple devices in communication with each other.

The document analysis module 201 may receive and analyse documents 209 from a database 210. In some embodiments, the document analysis module 201 may retrieve and analyse various details (i.e., attributes) of the documents 209. The document attributes may include, but are not limited to, metadata details, content categories, document access history, document modification history, and document access level. As will be appreciated, the attributes of the documents 209 may be required for subsequent processing by other modules 202-208 for classifying and managing the documents 209.

The domain data feeder module 202 may provide domain-specific intelligence to the ROT data management engine 200 in general, and the domain contextualized learning module 203 in particular. The domain-specific intelligence may include information from different domains including, but not limited to, healthcare, e-commerce, finance, utility, and retail. The information may include, but may not be limited to, a document retention policy, a document handling policy, and a document confidentiality policy for a specific domain. For example, in healthcare domain, the healthcare information may be maintained by differentiating different types of health records with different retention periods. In an exemplary scenario, mental health care records may need to be retained for a period of about 20 years, while maternity records may need to be retained for a period of about 25 years after the birth of the last child. Similarly, for example, in e-commerce applications, the customers may have about 18 months to dispute charges on their credit card bills and thus their transaction data may need to be retained for about 18 months. Additionally, for example, for information related to finance, tax returns documentation may need to be retained for at least 7 years, while personal financial records may need to be retained for about 5 years. Further, for example, in utility applications, the information may include customer utility bill details that may be stored for about 5 years.

The domain contextualized learning module 203 may receive the documents 209 from the database 210, the analysis of the documents 209 from the document analysis module 201, and the domain-specific intelligence from the domain data feeder module 202. The domain contextualized learning module 203 may then build a domain contextualized machine learning based document classification model. In some embodiments, the document classification model may be built by learning a relationship between domain knowledge and document attributes using a machine learning process. For example, the relationship may be learned by analyzing the domain-specific intelligence received from the domain data feeder module 202 and the document analysis inputs received from the document analysis module 201 using training data set as the reference. As will be appreciated, the domain contextualized learning module 203 may integrate the best of machine learning capabilities with a classification model that enriches the received data (for example, documents 209). In some embodiments, a classification model based on logistic regression associated with supervised machine learning may be employed. It should be noted that the training data set for the classification model may be categorized manually based on document type and domain specific knowledge.

The document classification module 204 may receive the document classification model (i.e., the learned relationship) from the domain contextualized learning module 203. The document classification module 204 may then classify the documents 209 into normal documents or ROT documents along with corresponding confidence scores using the document classification model. Thus, the document classification module 204 may automatically determine candidate ROT documents from among the documents 209 based on the learned relationship. As discussed above, the document classification model is a machine learning based classification model such as logistic regression associated with supervised machine learning. Each document may be classified using a training data set labeled with ROT related attributes. The ROT related attributes may be based on domain knowledge, document attributes, usage patterns, and so forth. For example, a utility bill that is more than 5 years old may be classified as a ROT document by the document classification module 204.

The usability and usage forecasting module 205 may receive analysis on the document 209 from the document analysis module 201. The usability and usage forecasting module 205 may then forecast usage and usability patterns of the documents. In some embodiments, the usage and usability patterns may be forecasted based on various parameters including, but not limited to, frequency of access to the documents, history of modifications to the documents, and number of other documents that have reference to the particular documents. As will be appreciated, the usage and usability patterns may provide information that helps in determining criticality or importance of the documents 209 based on the inputs received from the document analysis module 201. For example, the usability pattern of a document may correspond to a criticality of the document.

The ROT document management module 206 may receive a classification and a confidence score for each of the documents 209 from the document classification module 204, and the usage and usability patterns for each of the documents 209 from the usability and usage forecasting module 205. The ROT document management module 206 may then manage the documents 209 according to the document management policy based on the classification and the confidence score. In some embodiments, the ROT document management module 206 may segregate candidate ROT documents from candidate normal (i.e., non-ROT) documents. The ROT document management module 206 may further implement appropriate document management policy with respect to the segregated documents based on associated confidence scores. As will be appreciated, an acceptable level of confidence (i.e., confidence score above a pre-defined threshold) may help in taking definite action (e.g., deleting, archiving, etc.) for the segregated documents, while a low level of confidence (i.e., confidence score below the pre-defined threshold) may require a further review and analysis (for example, manual review and analysis). In some embodiments, the document management policy may include, but is not limited to, deleting the ROT document, marking the ROT document for further analysis, marking the normal document for further analysis, and storing the normal document. It should be noted that the acceptable level of confidence (for example, a first threshold for the ROT document and a second threshold for the normal document) may be pre-defined manually by the user. For example, the thresholds may be configured by the user based on the training data set size, training time, business adequacy and the like. Alternatively, the thresholds may be automatically derived and configured based on the supervised learning (initially) and the unsupervised learning (subsequently).

The segregated candidate ROT documents and candidate normal documents may be processed in different modules. The candidate ROT document handling module 207 may process the ROT documents, with acceptance level of confidence, for deletion. In some embodiments, the candidate ROT document handling module 207 may provide a notification and a brief summary on the ROT documents to the user, and request for a confirmation before performing the deletion. Further, the candidate ROT document handling module 207 may mark the ROT documents, with low level of confidence, for further review and analysis. Similarly, the candidate normal document handling module 208 may process the normal documents, with acceptance level of confidence, for storage. In some embodiments, the normal documents may be stored in a multi-tiered storage architecture based on usage and usability patterns. For example, less critical and less frequently used normal documents may be stored in a secondary or a low-cost storage, while frequently used priority documents may be stored in a primary or a high-cost storage. Further, the candidate normal document handling module 208 may mark the normal documents, with low level of confidence, for further review and analysis.

By way of an example, the ROT data management engine 200 may employ a domain contextualized machine learning based document classification model for classifying and managing data. In particular, a data classification model may be created, using domain contextualized machine learning, so as to classify documents into possible normal documents and possible ROT documents. In some embodiments, the data classification model may be based on logistic regression that is associated with a supervised machine learning. A training data set based on document type and domain-specific knowledge may be then fed to the data classification model. The outputs obtained from the data classification model may be reviewed to determine whether an acceptable level of confidence has been achieved. If the classification is at or above the acceptable level of confidence, then it indicates possible data for deletion or storage. However, if the classification is below the acceptable level of confidence, then further review and analysis may be performed by manual, automated, or semi-automated means.

By way of further example, the data classified as ROT data with an acceptable level of confidence may be discarded (i.e., deleted), while the data classified as non-ROT data (i.e., normal data) with an acceptable level of confidence may be stored. Further, the ROT data management engine 200 may identify criticality and usage patterns of the non-ROT data, which may then be stored accordingly using a multi-tiered storage architecture. Thus, less critical and less frequently used documents may be stored in a low-cost storage, while frequently used priority documents may be stored in a fast, high-cost storage.

In an exemplary scenario, in healthcare domain, the data to be managed by a healthcare organization may need to completely protect the health information of patients. Further, with time the data may become obsolete. In order to overcome such a problem, the data may be required to be maintained efficiently and effectively as per the data management policy of the healthcare domain. The ROT data management engine 200 may review the data, delete the obsolete data, and store the remaining data in a multi-tiered storage architecture based on usage and usability.

It should be noted that the ROT data management engine 200 may be implemented in programmable hardware devices such as programmable gate arrays, programmable array logic, programmable logic devices, and so forth. Alternatively, the ROT data management engine 200 may be implemented in software for execution by various types of processors. An identified engine of executable code may, for instance, include one or more physical or logical blocks of computer instructions which may, for instance, be organized as an object, procedure, function, module, or other construct. Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices.

As will be appreciated by one skilled in the art, a variety of processes may be employed for managing ROT data. For example, the exemplary system 100 and the associated ROT data management engine 200 may manage ROT documents by the processes discussed herein. In particular, as will be appreciated by those of ordinary skill in the art, control logic and/or automated routines for performing the techniques and steps described herein may be implemented by the system 100 and the ROT data management engine 200, either by hardware, software, or combinations of hardware and software. For example, suitable code may be accessed and executed by the one or more processors on the system 100 to perform some or all of the techniques described herein. Similarly application specific integrated circuits (ASICs) configured to perform some or all of the processes described herein may be included in the one or more processors on the system 100.

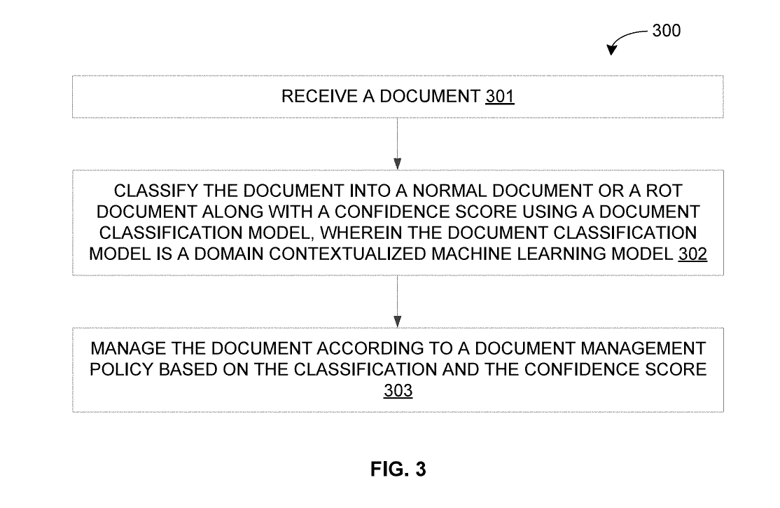

For example, referring now to FIG. 3, exemplary control logic 300 for managing ROT documents via a system, such as the system 100, is depicted via a flowchart in accordance with some embodiments of the present disclosure. As illustrated in the flowchart, the control logic 300 may include steps of receiving a document at step 301, classifying the document into a normal document or a ROT document along with a confidence score using a document classification model at step 302, and managing the document according to a document management policy based on the classification and the confidence score at step 303. It should be noted that the document classification model may be a domain contextualized machine learning model.

In some embodiments, the document management policy may include at least one of deleting the ROT document with the confidence score equaling or above a first pre-defined threshold, marking the ROT document with the confidence score below the first pre-defined threshold for further analysis, marking the normal document with the confidence score below a second pre-defined threshold for further analysis, or storing the normal document with the confidence score equaling or above the second pre-defined threshold.

Additionally, in some embodiments, the control logic 300 may further include the step of building the document classification model by learning a relationship between domain knowledge and document attributes using a machine learning process. As will be appreciated, in some embodiments, the relationship may be learned by analyzing the domain knowledge and the document attributes of a set of documents in a training data set. In some embodiments, the document attributes may include at least one of document metadata or content category of the document. Additionally, in some embodiments, the domain knowledge may include at least one of a document retention policy, a document handling policy, a document confidentiality policy for a domain. It should be noted that, in some embodiments, the domain comprises at least one of a healthcare domain, a finance domain, a utility domain, a retail domain, or an e-commerce domain.

Further, in some embodiments, the control logic 300 may also include the step of forecasting a usage pattern and a usability pattern of the document based on an analysis of the document. It should be noted that the usability pattern of the document may correspond to a criticality of the document. In some embodiments, the forecasting may be based on at least one of a frequency of access to the document, a history of modifications to the document, or a number of other documents that have reference to the document. Moreover, in some embodiments, the control logic 300 may include the step of storing the normal document in a multi-tiered storage architecture based on the usage pattern and the usability pattern. As will be appreciated, a less critical and less frequently used normal document is stored in a low-cost storage while a frequently used priority document is stored in a high-cost storage.

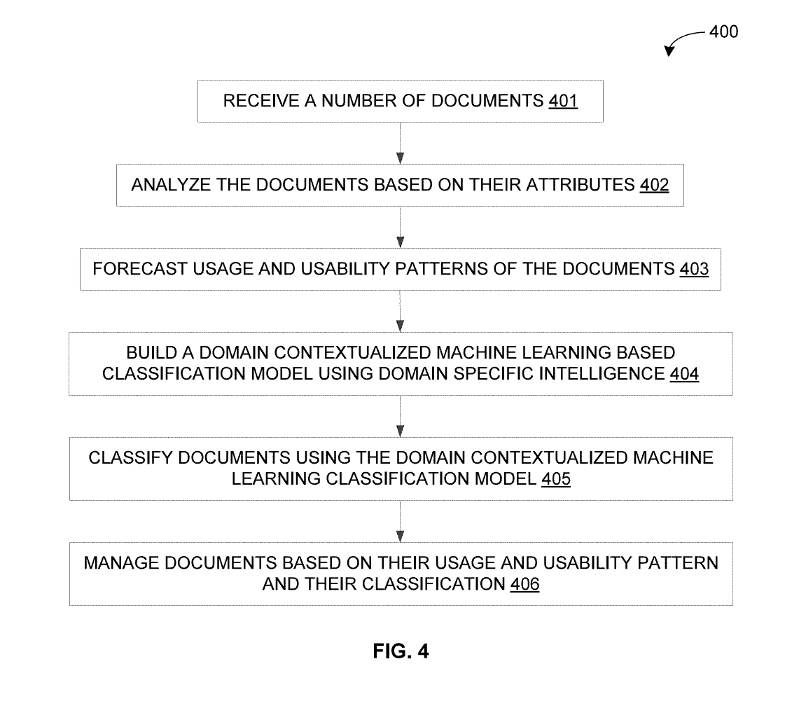

Referring now to FIG. 4, exemplary control logic 400 for managing ROT documents is depicted in greater detail via a flowchart in accordance with some embodiments of the present disclosure. As illustrated in the flowchart, at step 401, the control logic 400 may receive a number of documents from a database. At step 402, the control logic 400 may analyze the received documents. In some embodiments, the documents may be analyzed by retrieving and analyzing various details (i.e., attributes) of the documents. The details may include information such as metadata, content categories, history of access, history of modifications, and the like. As will be appreciated, the documents may be analyzed for details that may help in identifying and managing ROT documents. At step 403, the control logic 400 may forecast usage and usability patterns of the documents. In some embodiments, the usage and usability patterns may be forecasted based on the details derived from analysis of the documents at step 402. The documents may be further analyzed to determine respective importance or criticality based on usage and usability patterns of the documents.

At step 404, the control logic 400 may build a domain contextualized machine learning based classification model using domain specific intelligence for classifying and managing data. The domain-specific intelligence may be obtained from different domain data feeders (for example, healthcare, finance, utility, e-commerce, retail, and the like) for domain contextualized learning. As will be appreciated, the domain-specific intelligence may provide information that may help in managing documents such as by determining retention period of different documents according to their specific domain, by determining access rights of different documents according to their specific domain, and the like. As discussed above, the domain-specific intelligence and the details derived from analysis of the documents at step 402 may be further analyzed to learn the relationships between domain data and documents. It should be noted that the domain contextualized learning may be a machine learning process. The learning may then be employed to create a data classification model that helps in enriching the data for managing the data.

At step 405, the control logic 400 may classify documents using the domain contextualized machine learning classification model. The documents may be classified, using the details from document analysis and the relationships learned, as possible ROT documents or possible non-ROT documents. As will be appreciated, a training data set labeled with ROT related attributes based on domain, document attributes, usage patterns, and the like, may be used for the classification of each document.

At step 406, the control logic 400 may manage documents based on their usage and usability pattern and their classification. The documents may be segregated based on their classification as candidate ROT documents or candidate non-ROT documents along with corresponding levels of confidence. An acceptable level of confidence with respect to classification of the documents may be used in determining further action as per document management policy. For example, the candidate ROT documents may be potential for deletion (at or above acceptable level of confidence) or for further analysis (below acceptable level of confidence). Similarly, the candidate non-ROT documents may be potential for storage (at or above acceptable level of confidence) or for further analysis (below acceptable level of confidence). Further, the non-ROT documents to be stored may be managed by storing them in the multi-tiered storage architecture based on its usage and importance.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

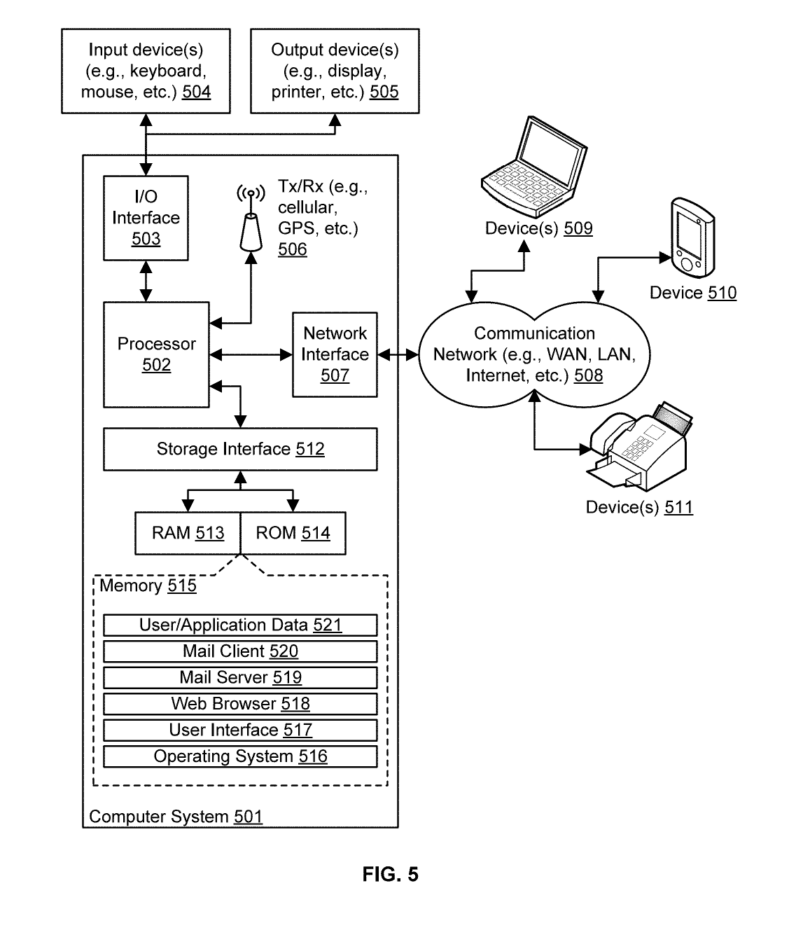

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 for managing ROT data. Computer system 501 may include a central processing unit (“CPU” or “processor”) 502. Processor 502 may include at least one data processor for executing program components for executing user-generated or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., documents, domain contextualized machine learning model, normal documents, ROT documents, confidence scores of classification, document management policy, domain knowledge, document attributes, training data, usage pattern, usability pattern, document access and modification history, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide for managing ROT data using a domain contextualized machine learning based document classification model. The techniques automate the ROT data identification process, and improve the accuracy of identification by employing machine learning and domain contextualization. The technique therefore helps in effectively and efficiently eliminating ROT data, thereby eliminating or minimizing the disadvantages associated with ROT data such as excessive storage and maintenance costs, compliance issues, impaired ability to quickly access the right information, increased vulnerability to data breaches, liability risk if stored beyond retention period, and so forth. The techniques described in the various embodiments discussed above further provide for efficient storage of non-ROT data, based on usage and usability patterns, with hierarchical data storage support.

The technique may be applicable in a large number of customer-oriented applications such as healthcare domain (hospital), financial institution (bank), telecommunication database, etc. In some embodiments, the domain contextualized learning module 203 and/or the document classification module 204 may further include various components such as, classification algorithms, clustering algorithms, semantic analysis, natural language processing, and so forth as per specificity of a particular application.

The specification has described method and system for managing ROT data. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of managing redundant, obsolete, and trivial (ROT) documents, the method comprising:
receiving, by a ROT data management device, a document;
classifying, by the ROT data management device, the document into a normal document or a ROT document along with a confidence score using a document classification model, wherein the document classification model is a domain contextualized machine learning model; and
managing, by the ROT data management device, the document according to a document management policy based on the classification and the confidence score.

2. The method of claim 1, further comprising building the document classification model by learning a relationship between domain knowledge and document attributes using a machine learning process.

3. The method of claim 2, wherein the relationship is learned by analyzing the domain knowledge and the document attributes of a set of documents in a training data set.

4. The method of claim 2, wherein the document attributes comprises at least one of document metadata or content category of the document.

5. The method of claim 2, wherein the domain knowledge comprises at least one of a document retention policy, a document handling policy, a document confidentiality policy for a domain, and wherein the domain comprises at least one of a healthcare domain, a finance domain, a utility domain, a retail domain, or an e-commerce domain.

6. The method of claim 1, wherein the document management policy comprises at least one of:
deleting the ROT document with the confidence score equaling or above a first pre-defined threshold,
marking the ROT document with the confidence score below the first pre-defined threshold for further analysis,
marking the normal document with the confidence score below a second pre-defined threshold for further analysis, or
storing the normal document with the confidence score equaling or above the second pre-defined threshold.

7. The method of claim 1, further comprising forecasting a usage pattern and a usability pattern of the document based on an analysis of the document, wherein the usability pattern of the document corresponds to a criticality of the document.

8. The method of claim 7, wherein the forecasting is based on at least one of a frequency of access to the document, a history of modifications to the document, or a number of other documents that have reference to the document.

9. The method of claim 7, further comprising storing the normal document in a multi-tiered storage architecture based on the usage pattern and the usability pattern, wherein a less critical and less frequently used normal document is stored in a low-cost storage while a frequently used priority document is stored in a high-cost storage.

10. A system for managing redundant, obsolete, and trivial (ROT) documents, the system comprising:
a ROT data management device comprising at least one processor and a computer-readable medium storing instructions that, when executed by the at least one processor, cause the at least one processor to perform operations comprising:
receive a document;
classify the document into a normal document or a ROT document along with a confidence score using a document classification model, wherein the document classification model is a domain contextualized machine learning model; and
manage the document according to a document management policy based on the classification and the confidence score.

11. The system of claim 10, wherein the operations further comprise building the document classification model by learning a relationship between domain knowledge and document attributes using a machine learning process, and wherein the relationship is learned by analyzing the domain knowledge and the document attributes of a set of documents in a training data set.

12. The system of claim 11, wherein the document attributes comprises at least one of document metadata or content category of the document, wherein the domain knowledge comprises at least one of a document retention policy, a document handling policy, a document confidentiality policy for a domain, and wherein the domain comprises at least one of a healthcare domain, a finance domain, a utility domain, a retail domain, or an e-commerce domain.

13. The system of claim 10, wherein the document management policy comprises at least one of:
deleting the ROT document with the confidence score equaling or above a first pre-defined threshold,
marking the ROT document with the confidence score below the first pre-defined threshold for further analysis,
marking the normal document with the confidence score below a second pre-defined threshold for further analysis, or
storing the normal document with the confidence score equaling or above the second pre-defined threshold.

14. The system of claim 10, wherein the operations further comprise forecasting a usage pattern and a usability pattern of the document based on at least one of a frequency of access to the document, a history of modifications to the document, or a number of other documents that have reference to the document, and wherein the usability pattern of the document corresponds to a criticality of the document.

15. The system of claim 14, wherein the operations further comprise storing the normal document in a multi-tiered storage architecture based on the usage pattern and the usability pattern, and wherein a less critical and less frequently used normal document is stored in a low-cost storage while a frequently used priority document is stored in a high-cost storage.

16. A non-transitory computer-readable medium storing computer-executable instructions for:
receiving a document;
classifying the document into a normal document or a ROT document along with a confidence score using a document classification model, wherein the document classification model is a domain contextualized machine learning model; and
managing the document according to a document management policy based on the classification and the confidence score.

17. The non-transitory computer-readable medium of claim 16, further storing computer-executable instructions for:
building the document classification model by learning a relationship between domain knowledge and document attributes using a machine learning process, wherein the relationship is learned by analyzing the domain knowledge and the document attributes of a set of documents in a training data set.

18. The non-transitory computer-readable medium of claim 16, wherein the document management policy comprises at least one of:
deleting the ROT document with the confidence score equaling or above a first pre-defined threshold,
marking the ROT document with the confidence score below the first pre-defined threshold for further analysis,
marking the normal document with the confidence score below a second pre-defined threshold for further analysis, or
storing the normal document with the confidence score equaling or above the second pre-defined threshold.

19. The non-transitory computer-readable medium of claim 16, further storing computer-executable instructions for:
forecasting a usage pattern and a usability pattern of the document based on at least one of a frequency of access to the document, a history of modifications to the document, or a number of other documents that have reference to the document, wherein the usability pattern of the document corresponds to a criticality of the document.

20. The non-transitory computer-readable medium of claim 16, further storing computer-executable instructions for:
storing the normal document in a multi-tiered storage architecture based on the usage pattern and the usability pattern, wherein a less critical and less frequently used normal document is stored in a low-cost storage while a frequently used priority document is stored in a high-cost storage.
